(19) United States
(12) Patent Application Publication
(10) Pub. No.: US 2024/0403881 A1
(43) Pub. Date: Dec. 5, 2024

(54) BLOCKCHAIN-BASED USER IDENTIFICATION METHOD AND ELECTRONIC DEVICE FOR PERFORMING THE SAME

(71) Applicant: 42dot Inc., Seoul (KR)

(72) Inventor: Geun Yong YUN, Yongin-si (KR)

(21) Appl. No.: 18/675,817

(22) Filed: May 28, 2024

(30) Foreign Application Priority Data
May 31, 2023 (KR) 10-2023-0069805
Jun. 5, 2023 (KR) 10-2023-0072416

(51) Int. Cl. G06Q 20/40; G06Q 50/47

(52) U.S. Cl. CPC G06Q 20/4014; G06Q 50/47

(57) ABSTRACT

An electronic device includes a memory including instructions; and a processor electrically connected to the memory and configured to execute the instructions, wherein, when the instructions are executed by the processor, the processor is configured to perform a plurality of operations: recording a driver registration result of a vehicle owner in profile data stored in a blockchain; and generating a combination identifier (CID) in which a vehicle and a driver are mapped by mapping vehicle information and driver information recorded in the profile data, wherein the CID is segmented into blockchain-based decentralized identifiers (DIDs) respectively corresponding to vehicle usage scenarios of the driver and includes at least one of vehicle information, driver information, vehicle owner information, or CID type information.

### CROSS-REFERENCE TO RELATED APPLICATIONS

This application claims the benefit under 35 USC § 119 (a) of Korean Patent Application No. 10-2023-0069805 filed on May 31, 2023, and Korean Patent Application No. 10-2023-0072416 filed on Jun. 5, 2023, in the Korean Intellectual Property Office, the entire disclosures of which are incorporated herein by reference for all purposes.

### BACKGROUND

### 1. Field

The following description relates to a blockchain-based user identification method and an electronic device performing the blockchain-based user identification method.

### 2. Description of Related Art

As the number of users of mobility services such as ridesharing and car rental services, the mobility industry has seen significant growth in recent years. However, a currently used user account framework for mobility services is limited and inflexible and has limitations in responding to various service scenarios.

Most mobility services treat vehicles and drivers as separate individual service entities, and thus there may be difficulties when a user desires to share their vehicle with another driver or when a user desires to use their subscribed services in a rented vehicle. Therefore, there is a need for a more efficient and flexible user account framework.

The above description is information the inventor(s) acquired during the course of conceiving the present disclosure, or already possessed at the time, and is not necessarily art publicly known before the present application was filed.

### SUMMARY

According to an example embodiment, there is provided an electronic device including: a memory comprising instructions; and a processor electrically connected to the memory and configured to execute the instructions. When the instructions are executed by the processor, the processor may be configured to perform a plurality of operations, and the plurality of operations may include: recording a driver registration result of a vehicle owner in profile data stored in a blockchain; and generating a combination identifier (CID) in which a vehicle and a driver are mapped by mapping vehicle information and driver information recorded in the profile data. The CID may be segmented into blockchain-based decentralized identifiers (DIDs) respectively corresponding to vehicle usage scenarios of the driver, and the CID may include at least one of vehicle information, driver information, vehicle owner information, or CID type information.

The profile data may include: a profile base storing a vehicle list, a driver list, and vehicle owner information; and a profile list storing a CID list and CID type information.

The CID type information may include information about a vehicle-driver relationship.

The profile base and the profile list may be configured to store information in the form of a table and to manage the information in a tree structure.

The plurality of operations may further include, in response to a request for a DID corresponding to a vehicle usage scenario of the driver, issuing a DID corresponding to the vehicle usage scenario and based on the CID.

The plurality of operations may further include, in response to a request for a verifiable credential (VC) from the driver, issuing a VC based on the DID. The VC may correspond to a credential owned by the driver or a credential delegated to the driver.

The VC may correspond to a vehicle operation credential or a vehicle service usage credential.

The DID and the VC may be used to generate a verifiable presentation (VP) corresponding to the vehicle usage scenario of the driver.

The VP may be used to authenticate and authorize a vehicle-related service the driver desires to receive.

According to an example embodiment, there is provided a blockchain-based user identification method for a mobility service, the method including: recording a driver registration result of a vehicle owner in profile data stored in a blockchain; and generating a CID in which a vehicle and a driver are mapped by mapping vehicle information and driver information recorded in the profile data. The CID may be segmented into blockchain-based DIDs respectively corresponding to vehicle usage scenarios of the driver, and the CID may include at least one of vehicle information, driver information, vehicle owner information, or CID type information.

The profile data may include a profile base storing a vehicle list, a driver list, and vehicle owner information; and a profile list storing a CID list and CID type information.

The CID type information may include information about a vehicle-driver relationship.

The profile base and the profile list may be configured to store information in the form of a table and to manage information in a tree structure.

The method may further include, in response to a request for a DID corresponding to a vehicle usage scenario of the driver, issuing a DID corresponding to the vehicle usage scenario and based on the CID.

The method may further include, in response to a request for a VC from the driver, issuing a VC based on the DID. The VC may correspond to a credential owned by the driver or a credential delegated to the driver.

The VC may correspond to a vehicle operation credential or a vehicle service usage credential.

The DID and the VC may be used to generate a VP corresponding to the vehicle usage scenario of the driver.

The VP may be used to authenticate and authorize a vehicle-related service the driver desires to receive.

Other features and aspects will be apparent from the following detailed description, the drawings, and the claims.

### BRIEF DESCRIPTION OF THE DRAWINGS

FIG. 1 is a diagram illustrating a blockchain-based user identification system according to an example embodiment.

FIG. 2 is a block diagram schematically illustrating an electronic device according to an example embodiment.

FIG. 3 is a diagram illustrating a combination identifier (CID) according to an example embodiment.

FIG. 4 is a diagram illustrating a decentralized identifier (DID) segmented from a CID according to an example embodiment.

FIG. 5 is a diagram illustrating a mobility service providing method using a DID-based VP according to an example embodiment.

FIG. 6 is a flowchart illustrating a blockchain-based user identification method according to an example embodiment.

FIG. 7 is a diagram illustrating a vehicle history management system according to an example embodiment.

FIG. 8 is a diagram schematically illustrating a structure of a profile block according to an example embodiment.

FIG. 9 is a diagram illustrating a connection relationship between a first-type profile block and a second-type profile block according to an example embodiment.

FIG. 10 is a diagram illustrating a connection relationship among a first-type profile block, a second-type profile block, and a third-type profile block according to an example embodiment.

FIG. 11 is a flowchart illustrating a blockchain structure-based user-associated vehicle history management method according to an example embodiment.

FIG. 12 is a block diagram illustrating a blockchain structure-based user-associated vehicle history management device according to an example embodiment.

### DETAILED DESCRIPTION

The following structural or functional descriptions of example embodiments are merely intended for the purpose of describing the example embodiments, and the example embodiments may be implemented in various forms. The example embodiments are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component, or intervening components may be present.

As used herein, “A or B,” “at least one of A and B,” “at least one of A or B,” “A, B or C,” “at least one of A, B and C,” and “A, B, or C,” each of which may include any one of the items listed together in the corresponding one of the phrases, or all possible combinations thereof. The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

As used in connection with various example embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an example embodiment, the module may be implemented in the form of an application-specific integrated circuit (ASIC).

As used herein, the term “unit” (or “-er/or”) refers to software or hardware components such as a field-programmable gate array (FPGA) or an ASIC, and the unit may perform some functions. However, the unit is not limited to software or hardware. The unit may be configured to be on an addressable storage medium or may be configured to operate one or more processors. For example, the unit may include components, such as, software components, object-oriented software components, class components, and task components, processes, functions, attributes, procedures, subroutines, segments of program code, drivers, firmware, microcode, circuits, data, databases (DBs), data structures, tables, arrays, and variables. The functionality provided within components and units may be combined into fewer components and units or further separated into additional components and units. Further, the components and units may be implemented to operate one or more central processing units (CPUs) in a device or security multimedia card. Furthermore, the unit or -er/or may include one or more processors.

Hereinafter, example embodiments will be described in detail with reference to the accompanying drawings. When describing the example embodiments with reference to the accompanying drawings, like reference numerals refer to like components and a repeated description related thereto is omitted.

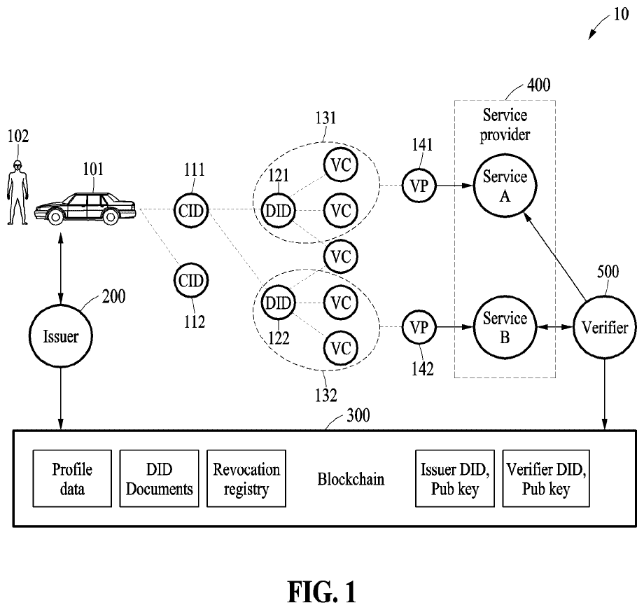

Hereinafter, a blockchain-based user identification method will be described with reference to FIGS. 1 through 6 according to an example embodiment.

FIG. 1 is a diagram illustrating a blockchain-based user identification system according to an example embodiment.

Referring to FIG. 1, according to an example embodiment, a blockchain-based user identification system 10 may be a system for efficient verification (e.g., authentication and/or authorization) of user (e.g., driver) identification and/or vehicle-related services, in response to diversified vehicle usage scenarios.

The blockchain-based user identification system 10 may be a system that uses a combination identifier (CID) (e.g., CIDs 111 and 112). The CIDs 111 and 112 may be issued by an issuer 200. The CID 111 in which a vehicle 101 and a driver 102 are mapped may be generated based on a driver registration of a vehicle owner (e.g., an owner of the vehicle 101, e.g., the driver 102 and the owner of the vehicle 101 may be different according to situations). The CID 111 may be segmented into blockchain-based decentralized identifiers (DIDs) (e.g., DIDs 121 and 122) respectively corresponding to vehicle usage scenarios of the driver 102.

The DIDs 121 and 122 may be distributed IDs based on a blockchain 300. The DID DIDs 121 and 122 may be issued by the issuer 200. The DIDs 121 and 122 may correspond to the vehicle usage scenarios of the driver 102. For example, the DID 121 may correspond to a first vehicle usage scenario of the driver 102. For example, the DID 122 may correspond to a second vehicle usage scenario of the driver 102. A vehicle usage scenario may include credentials (or rights) of a driver. A vehicle usage scenario may correspond to a combination of a vehicle, a driver, and credentials.

A verifiable credential (VC) may be used to authenticate an identity or prove a specific credential. The VC may be issued by the issuer 200. The VC may correspond to a credential of a driver (e.g., the driver 102), and the credential may be, for example, an owned credential which is a credential owned by the driver and a delegated credential which is a credential delegated to the driver and may include, for example, a vehicle operation credential and/or a vehicle feature on demand (FOD) service usage credential. The VC may include a credential ID, an issuer ID (e.g., an ID of the issuer 200), a holder ID (e.g., an ID of the driver 102), claims (e.g., credential data), and a signature of an issuer (e.g., the issuer 200). The claims (e.g., credential data) may include information about credentials of a driver (e.g., the driver 102), for example, an owned credential, a sharing credential, driver's license information, membership information, a vehicle operation contract, and the like. The VC may be mapped to a DID corresponding to a vehicle usage scenario of a driver (e.g., the driver 102), as indicated in 131 and 132, for example.

A verifiable presentation (VP) (e.g., VPs 141 and 142) may be used to verify a specific credential or information by submitting a portion or entirety of a VC to a verifier 500. The VPs 141 and 142 may be used to verify (e.g., authenticate and/or authorize) a vehicle-related service the driver 102 desires to receive. The VPs 141 and 142 may selectively include only information required to use the vehicle-related service. For example, the VP 141 may be a combination of one DID (e.g., the DID 121) and at least one VC. The VPs 141 and 142 may include a VC and a signature of a holder (e.g., the driver 102). The VPs 141 and 142 may correspond to vehicle usage scenarios of the driver 102. For example, the VP 141 may correspond to a first vehicle usage scenario of the driver 102. For example, the VP 142 may correspond to a second vehicle usage scenario of the driver 102.

A service provider 400 (e.g., a provider of a vehicle-related service) may perform driver identification and/or vehicle-related service verification (e.g., authentication and/or authorization) using the VPs 141 and 142. The service provider 400 (e.g., a provider of a vehicle-related service) may include a vehicle manufacturer, a vehicle FOD service provider, a vehicle rental company, a fleet management company, and the like.

The service provider 400 may transmit a VP (e.g., 141 and 142) to a verifier 500 and request the driver identification and/or the vehicle-related service verification (e.g., authentication and/or authorization). The verifier 500 may use the VP (e.g., 141 and 142) to identify a driver (e.g., the driver 102) and/or verify (e.g., authenticate and/or authorize) a vehicle-related service the driver 102 desires to receive. The verifier 500 may transmit a verification result to the service provider 400, and the service provider 400 may selectively provide the vehicle-related service to the driver 102 based on the received verification result.

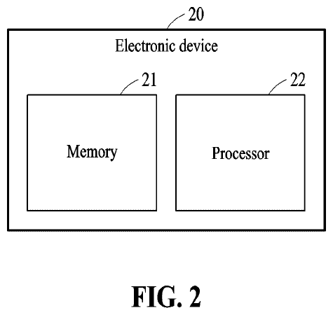

FIG. 2 is a block diagram schematically illustrating an electronic device according to an example embodiment.

Referring to FIG. 2, according to an example embodiment, an electronic device 20 may respond to diversified vehicle usage scenarios by using a CID that is to be segmented into DIDs. In response to the diversified vehicle usage scenarios, the electronic device 20 may efficiently perform user (e.g., driver) identification and/or vehicle-related service verification (e.g., authentication and/or authorization). The electronic device 20 may provide efficient and flexible services in response to the diversified vehicle usage scenarios.

The electronic device 20 may refer to a terminal of an issuer (e.g., the issuer 200 in FIG. 1). The electronic device 20 may also serve as a terminal of a verifier (e.g., the verifier 500 in FIG. 1). When describing an issuer and/or a verifier herein, information transmission/reception therebetween may be construed that the information transmission/reception is performed through respective terminals (e.g., computing devices, electronic devices, and servers) of the issuer and/or the verifier.

The electronic device 20 may record a driver registration result of a vehicle owner in profile data stored in a blockchain (e.g., the blockchain 300 in FIG. 1). A driver registration of the vehicle owner may be by an interaction between the vehicle owner and a vehicle (e.g., the vehicle 101 in FIG. 1) (e.g., an interface in the vehicle). The driver registration of the vehicle owner may be by an interaction between the vehicle owner and a terminal (e.g., a portable device, a personal computer (PC), etc.) of the vehicle owner. The electronic device 20 may receive the driver registration result from the vehicle or the terminal of the vehicle owner and may record the received driver registration result in the profile data stored in the blockchain.

The electronic device 20 may map vehicle information and driver information recorded in the profile data to generate a CID (e.g., a vehicle-driver mapped CID). As described above, the CID may be segmented into blockchain-based DIDs.

The electronic device 20 may issue a DID based on the CID in response to a request for a DID from a driver (e.g., the driver 102 in FIG. 1). The request for a DID will also be shortly referred to as a DID request, hereinafter. The DID request of the driver received by the electronic device 20 may be one that is received by the electronic device 20 from a terminal (or server) of the driver. In this case, the terminal (or server) of the driver may receive an input from the driver through an interface, and the terminal (or server) of the driver may transmit the input of the driver to the electronic device 20.

The electronic device 20 may respond to the driver (or the terminal of the driver) with the issued DID. The electronic device 20 may record the issued DID (or information about the DID) in the blockchain (e.g., a DID document stored in the blockchain).

The electronic device 20 may issue a VC based on the DID in response to a request for a VC from the driver. The request for a VC will also be shortly referred to as a VC request, hereinafter. The VC request of the driver received by the electronic device 20 may be one that is received by the electronic device 20 from the terminal (or server) of the driver. It should be noted that operations described herein as being performed by the driver are performed by the terminal (or server) of the driver.

The electronic device 20 may respond to the driver (or the terminal of the driver) with the issued VC. The electronic device 20 may record the issued VC in the blockchain (e.g., the blockchain 300 in FIG. 1).

The electronic device 20 may use a VP in which the DID and at least one VC are combined to identify the driver and/or verify (e.g., authenticate and/or authorize) a vehicle-related service the driver desires to receive. The electronic device 20 may also perform operations of the verifier (e.g., the verifier 500 in FIG. 1), but examples are not limited thereto.

The electronic device 20 may be implemented in a vehicle (or a car), a PC, a data server, or a portable device.

The portable device may be implemented as, for example, a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, or a smart device. The smart device may be implemented as, for example, a smart watch, a smart band, or a smart ring.

The electronic device 20 may include a processor 22 and a memory 21.

The processor 22 may process data stored in the memory 21. The processor 22 may execute computer-readable code (e.g., software) stored in the memory 21 and instructions caused by the processor 22.

The processor 22 may be a hardware-implemented data processing device with physically structured circuitry for executing desired operations. The desired operations may include, for example, code or instructions included in a program.

The hardware-implemented data processing device may include, for example, a microprocessor, a central processing unit (CPU), a processor core, a multi-core processor, a multiprocessor, an application-specific integrated circuit (ASIC), or a field-programmable gate array (FPGA).

The memory 21 may store relational data and/or metagraphs. The memory 21 may be implemented as a volatile memory device or a non-volatile memory device.

The volatile memory device may be implemented as, for example, a dynamic random-access memory (DRAM), a static random-access memory (SRAM), a thyristor RAM (T-RAM), a zero capacitor RAM (Z-RAM), or a twin transistor RAM (TTRAM).

The non-volatile memory device may be implemented as, for example, an electrically erasable programmable read-only memory (EEPROM), a flash memory, a magnetic RAM (MRAM), a spin-transfer torque MRAM (STT-MRAM), a conductive bridging RAM (CBRAM), a ferroelectric RAM (FeRAM), a phase-change RAM (PRAM), a resistive RAM (RRAM), a nanotube RRAM, a polymer RAM (PoRAM), a nano-floating gate memory (NFGM), a holographic memory, a molecular electronic memory device, or an insulator resistance change memory.

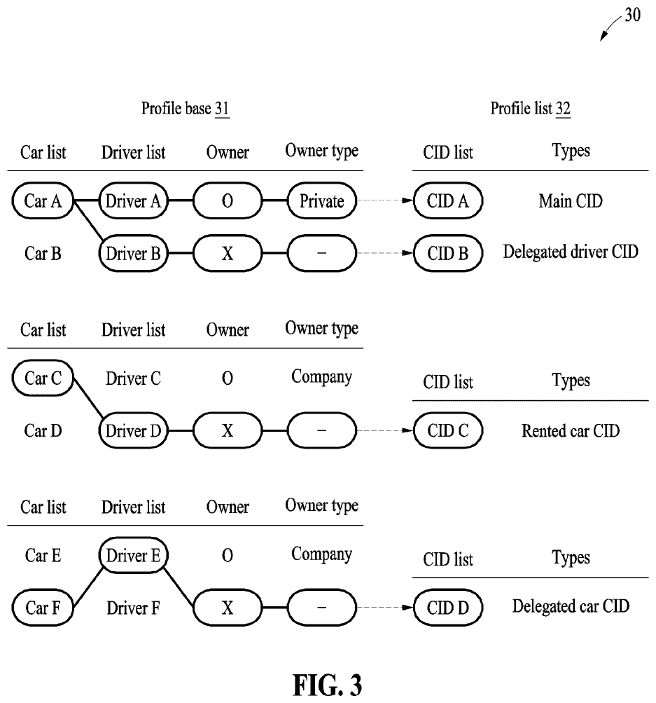

FIG. 3 is a diagram illustrating a CID according to an example embodiment.

Referring to FIG. 3, according to an example embodiment, an issuer (e.g., the issuer 200 in FIG. 1) may record a driver registration result of a vehicle owner in profile data 30 stored in a blockchain (e.g., the blockchain 300 in FIG. 1). The electronic device 20 may map vehicle information and driver information recorded in the profile data 30 to generate a vehicle-driver mapped CID (e.g., CID A, CID B, CID C, and CID D). The CID may include vehicle information, driver information, vehicle owner information, and/or CID type information. The CID type information may include information about a vehicle-driver relationship. On a vehicle's side, the vehicle-driver relationship may be classified into 1) the vehicle and a vehicle owner and 2) the vehicle and a delegated driver. On a driver's side, the vehicle-driver relationship may be classified into 1) the driver and a vehicle owned by the driver, 2) the driver and a vehicle (e.g., a rented car) rented by the driver, and 3) the driver and a vehicle (e.g., a delegated car) delegated to the driver. Since the CID is generated based on the vehicle, various examples (e.g., the examples described above) of the vehicle-driver relationship may differ only in how they are expressed.

The profile data 30 may include a profile base 31 storing a vehicle list (e.g., “Car list” in FIG. 3), a driver list (e.g., “Driver list” in FIG. 3), vehicle owner information (e.g., “Owner” and “Owner type” in FIG. 3), and a profile list 32 storing a CID list (e.g., “CID list” in FIG. 3) and CID type information (e.g., “Types” in FIG. 3). The profile base 31 and the profile list 32 may be configured to store information in the form of a table. The profile base 31 and the profile list 32 may be configured to manage the information in a tree structure.

A CID may be generated based on a vehicle. For example, the CID (e.g., CID A) may be one in which a vehicle (e.g., Car A) and a driver (e.g., a vehicle owner) (e.g., Driver A) are mapped, and may be generated based on a driver registration (e.g., initial registration, or mapping Driver A and Car A) of the vehicle owner (e.g., Driver A). For example, the CID (e.g., CID B) may be one in which a vehicle (e.g., Car A) and a driver (e.g., a delegated driver) (e.g., Driver B) are mapped, and may be generated based on a driver registration (e.g., mapping Driver B and Car A) of the vehicle owner (e.g., Driver A).

A driver may be classified into a vehicle owner (e.g., Driver A) and a driver to whom a vehicle operation credential is delegated by the vehicle owner (e.g., Driver A) (hereinafter, a delegated driver) (e.g., Driver B). That is, the CID may include a vehicle-vehicle owner mapped CID (e.g., main CID or initial CID) (e.g., CID A) and a vehicle-delegated driver mapped CID (e.g., CID B, CID C, and CID D).

When there is a CID, the CID may not be newly generated but be selected in response to a DID request from a driver. The CID may be segmented into blockchain-based DIDs respectively corresponding to vehicle usage scenarios of the driver.

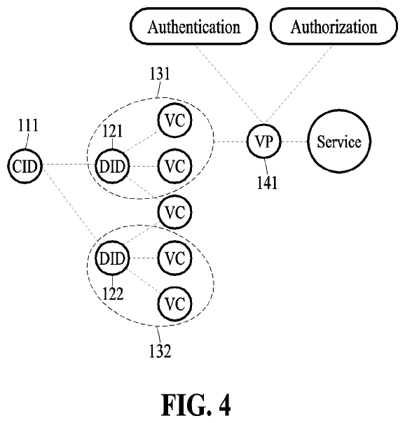

FIG. 4 is a diagram illustrating DIDs segmented from a CID according to an example embodiment.

Referring to FIG. 4, according to an example embodiment, in response to a DID request from a driver, a CID 111 may be selected, and a DID (e.g., DIDs 121 and 122) may then be issued and/or selected based on the CID 111. The DID (e.g., the DIDs 121 and 122) may be a blockchain-based distributed identifier. The DID (e.g., the DIDs 121 and 122) may correspond to a vehicle usage scenario of the driver. For example, the DID 121 may correspond to a first vehicle usage scenario of the driver. For example, the DID 122 may correspond to a second vehicle usage scenario of the driver. The vehicle usage scenario may include credentials of the driver. The vehicle usage scenario may correspond to a combination of a vehicle, the driver, and the credentials.

A VC may be used to authenticate identity or prove a specific credential. The VC may correspond to a credential of a driver, for example, an owned credential which is a credential owned by the driver and/or a delegated credential which is a credential delegated to the driver, (e.g., a vehicle operation credential and/or a vehicle FOD service usage credential). The VC may be mapped to a DID corresponding to a vehicle usage scenario of the driver, as shown in 131 and 132, for example.

A VP (e.g., a VP 141) may include a portion or entirety of the VC. The VP may be used to identify a user (e.g., a driver) and/or verify (e.g., authenticate and/or authorize) a vehicle-related service the driver desires to receive.

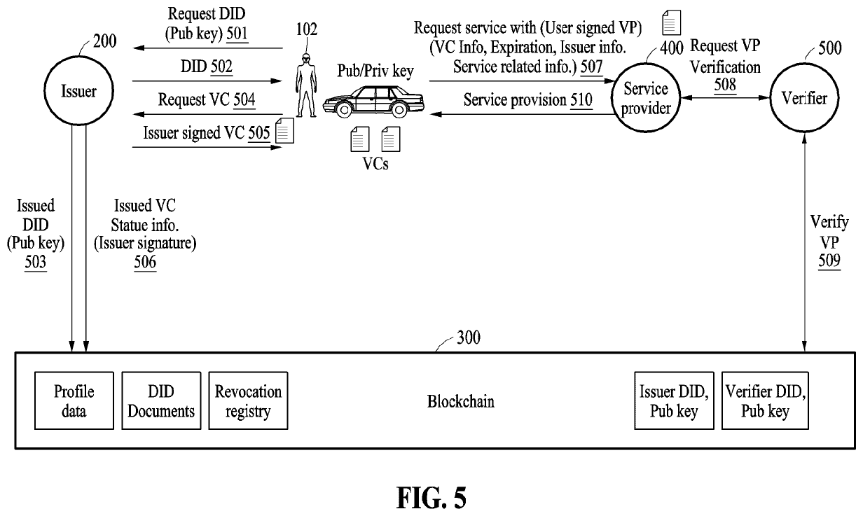

FIG. 5 is a diagram illustrating a mobility service providing method using a DID-based VP according to an example embodiment.

Referring to FIG. 5, user identification and/or vehicle-related service verification may be performed using a VP. As described above, a blockchain-based user identification system (e.g., the blockchain-based user identification system 10 in FIG. 1) may be a system that uses a CID. The CID may be issued by an issuer 200. The CID may be newly generated at the request of a driver 102, or an existing CID may be selected in response to a DID request from the driver 102. In this case, the request (e.g., a CID request or a DID request) of the driver 102 received by the issuer 200 may be one that is received by the issuer 200 from a terminal (or server) of the driver 102. For example, the terminal (or server) of the driver 102 may receive an input from driver 102 through an interface, and the terminal (or server) of the driver 102 may transmit the input of the driver 120 to the issuer 200 and/or a service provider 400. Hereinafter, it may be construed that operations described herein as being performed by the driver 102 may be performed through the terminal (e.g., a computing device, an electronic device, a server, etc.) of the driver 102.

The driver 102 may request the issuer 200 for a DID corresponding to a vehicle usage scenario in step 501. The issuer 200 may respond to the driver 102 with a newly issued and/or selected DID in step 502. Since the issued and/or selected DID may be one that is segmented from the CID, the issuance and/or selection of the DID may be performed after the selection of the CID. The issuer 200 may record the issued and/or selected DID in a blockchain 300 in step 503.

The driver 102 may request the issuer 200 for a credential required (or necessary) for the vehicle usage scenario and a corresponding VC in step 504. The issuer 200 may issue the VC based on the DID in step 505. The VC may correspond to the credential of the driver 102, for example, an owned credential and/or a delegated credential (e.g., a vehicle operation credential and/or a vehicle FOD service usage credential). The VC may be mapped to the DID corresponding to the vehicle usage scenario of the driver 102. The VC may include a signature of the issuer 200. The issuer 200 may record the issued VC in the blockchain 300 in step 506.

The driver 102 may combine VCs to generate a VP. The driver 102 may select credentials to be used by the driver 102 when using a vehicle. In this case, the driver 102 may combine VCs corresponding to the selected credentials to generate a VP. The VP may correspond to a vehicle usage scenario. The vehicle usage scenario may include a selective combination of the credentials to be used by the driver 102 when using the vehicle.

The driver 102 may submit the VP to a service provider 400 (e.g., a vehicle-related service provider) to request a service in step 507. The vehicle-related service provider may include a vehicle manufacturer, a vehicle FOD service provider, a vehicle rental company, a fleet management company, and the like.

The service provider 400 may transmit the VP to a verifier 500 to request the verifier 500 for driver identification and vehicle-related service verification (e.g., authentication and/or authorization) in step 508.

The verifier 500 may use the VP to identify the driver 102 and/or verify (e.g., authenticate and/or authorize) a vehicle-related service the driver 102 desires to receive in step 509. The verifier 500 may transmit a verification result to the service provider 400, and the service provider 400 may selectively provide the vehicle-related service to the driver 102 based on the received verification result in step 510.

The blockchain-based user identification system (e.g., the blockchain-based user identification system 10 in FIG. 1) may be a system efficient in user (e.g., driver) identification and/or vehicle-related service verification (e.g., authentication and/or authorization) in response to diversified vehicle usage scenarios.

The blockchain-based user identification system 10 may respond to diversified vehicle usage scenarios by using a CID segmented into DIDs. The blockchain-based user identification system 10 may efficiently perform user (e.g., driver) identification and/or vehicle-related service verification (e.g., authentication and/or authorization) in response to the diversified vehicle usage scenarios. The blockchain-based user identification system 10 may provide efficient and flexible services in response to the diversified vehicle usage scenarios.

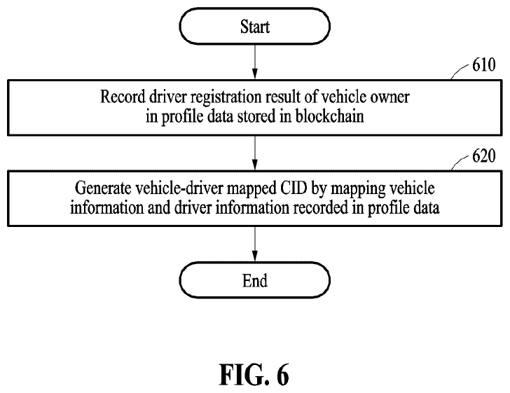

FIG. 6 is a flowchart illustrating a blockchain-based user identification method according to an example embodiment.

Referring to FIG. 6, according to an example embodiment, operations 610 and 620 may be performed in sequential order but are not necessarily performed in sequential order. For example, two or more operations may be performed in parallel. Operations 610 and 620 may be substantially the same as the operations of an electronic device (e.g., the electronic device 20 in FIG. 2) described above with reference to FIGS. 1 through 5, and thus what has already been described above will not be repeated here.

In operation 610, the electronic device 20 may record a driver registration result of a vehicle owner in profile data stored in a blockchain.

In operation 620, the electronic device 20 may generate a CID in which a vehicle and a driver are mapped by mapping vehicle information and driver information recorded in the profile data. The CID may be segmented into blockchain-based DIDs corresponding to vehicle usage scenarios of the driver. The CID may include at least one of vehicle information, driver information, vehicle owner information, or CID type information.

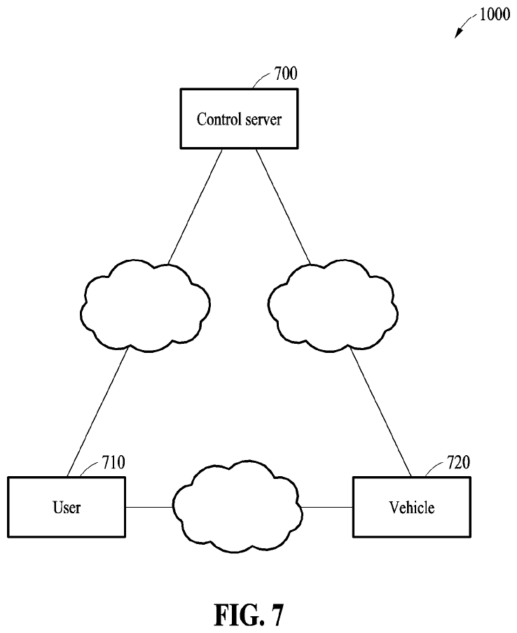

Hereinafter, a method of managing a history of a vehicle associated with a user based on a blockchain, or simply a “vehicle history management method,” according to an example embodiment will be described with reference to FIGS. 7 through 12.

FIG. 7 is a diagram illustrating a vehicle history management system according to an example embodiment.

According to an example embodiment, a system 1000 may include a control server 700, a user 710, and a vehicle 720. Although only components related to an example embodiment of the system 1000 are shown in FIG. 7, it is apparent to those having ordinary skill in the art that the system 1000 may include other general-purpose components in addition to those shown in FIG. 7.

In addition, although one user (e.g., the user 710) and one vehicle (e.g., the vehicle 720) are shown in FIG. 7 for ease of understanding, the system 1000 may include one or more users 710 and one or more vehicles 720, and the control server 700 may control the one or more users 710 and the one or more vehicles 720.

The control server 700, the user 710, and the vehicle 720 may communicate using a network. The network may be a data communication network in the broadest sense that allows different entities to communicate with each other seamlessly and may include wired Internet, wireless Internet, and mobile wireless communication networks. The network may include, for example, a local area network (LAN), a wide area network (WAN), a value-added network (VAN), a mobile radio communication network, a satellite communication network, and any combination thereof. The wireless communication may include, as non-limiting examples, wireless LAN (e.g., Wi-Fi), Bluetooth, Bluetooth low energy (BLE), ZigBee, Wi-Fi direct (WFD), ultra-wideband (UWB), infrared data association (IrDA), and near-field communication (NFC).

In addition, although one user (e.g., the user 710) and one vehicle (e.g., the vehicle 720) are shown in FIG. 7 for ease of understanding, the system 1000 may include one or more users and one or more vehicles 720, and the control server 700 may control the one or more users 710 and the one or more vehicles 720.

The control server 700 may be implemented as a computer device or a plurality of computer devices that communicate over the network to provide commands, code, files, contents, services, and the like.

The control server 700 may transmit and receive data to and from the user 710 and the vehicle 720 over the network and may perform various control functions of the control server 700. The control server 700 may also assist the vehicle 720 in driving.

The control server 700 may perform a central operation of operating the system 1000, which is a “vehicle history management system” according to an embodiment. For example, the control server 700 may provide the user 710 with a service related to the vehicle 720 (or a “vehicle usage service”). The vehicle usage service may include a service provided to allow the user 710 to use the vehicle 720 before using the vehicle 720, a service provided while the user 710 is using the vehicle 720, and a service provided after the user 710 uses the vehicle 720.

The service provided to allow the user 710 to use the vehicle 720 may include, for example, providing a process for selecting the vehicle 720 to be used by the user 710, providing information about the vehicle 720 scheduled to be used, providing a driving record of the vehicle 720 scheduled to be used, and the like. The service provided while the user 710 is using the vehicle 720 may include, for example, providing driving-related information of the vehicle 720, assisting in driving the vehicle 720, and the like. The service provided after the user 710 uses the vehicle 720 may include, for example, providing a driving record of the vehicle 720, providing information for managing the vehicle 720, and the like.

The user 710 may refer to an entity that receives a vehicle usage service, and the user 710 may also be construed as a device owned or used by the user 710. The user 710 may communicate with the control server 700 or the vehicle 720 over the network to receive the vehicle usage service.

The vehicle 720 may communicate with other vehicles or other nodes over the network. The vehicle 720 may also be construed as a device mounted on the vehicle 720.

In an example embodiment, the device mounted on the vehicle 720 may be an autonomous driving device. The autonomous driving device may refer to a device that is mounted on the vehicle 720 to implement an autonomous (driving) vehicle.

The device mounted on the vehicle 720 may include various sensors (including cameras) to collect situational information therearound. For example, the device mounted on the vehicle 720 may detect a movement of a vehicle traveling in front of the vehicle 720 via image sensors and/or event sensors mounted on the front of the vehicle 720. The device mounted on the vehicle 720 may further include sensors configured to detect other vehicles traveling on neighboring lanes in addition to vehicles traveling in the front of the vehicle 720, pedestrians present around the vehicle 720, and the like. The device mounted on the vehicle 720 may further include various types of sensors configured to collect information about the surroundings of the vehicle 720.

The vehicle 720 may be owned by the user 710 or by a third party, or be temporarily used or scheduled to be used by the user 710.

The above-described operation of managing a history of a vehicle associated with a user based on a blockchain structure (or simply a “blockchain structure-based user-associated vehicle history management operation” or more simply a “vehicle history management operation”) may be performed by a device configured to manage a history of a vehicle associated with a user based on a blockchain structure (or simply a “blockchain structure-based user-associated vehicle history management device” or more simply a “vehicle history management device”) and, more specifically, by a processor of the blockchain structure-based user-associated vehicle history management device.

According to an example embodiment, the blockchain structure-based user-associated vehicle history management device may be provided in the control server 700, the user 710, or the vehicle 720, and may be construed as being a device on the control server 700, the user 710, or the vehicle 720, or as being a part of the control server 700, the user 710, or the vehicle 720.

According to an example embodiment, the blockchain structure-based user-associated vehicle history management device may manage a history of a vehicle associated with a user by generating a profile block including user information, a profile block including vehicle information, a profile block including vehicle-related sub-information, and the like, and forming a chain between the generated profile blocks. Hereinafter, operations performed by the blockchain structure-based user-associated vehicle history management device will be described in more detail.

According to an example embodiment, a history of a vehicle may be associated with a user, and may not simply indicate a history of a specific vehicle but a history that matches information about the user.

For example, in a case where a first vehicle is owned by a first user, a history of the first vehicle associated with the first user may be generated as the first user owns the first vehicle, and may include information about the first vehicle, information about how the first user owns the first vehicle, information generated as the first user uses the first vehicle thereafter, driving information, and the like.

For example, in a case where the first user is scheduled to use a second vehicle that is owned by a third party, a history of the second vehicle associated with the first user may be generated as the first user obtains a credential to use the second vehicle, and may include information about the second vehicle, information about the credential for using the second vehicle, information generated as the first user uses the second vehicle thereafter, driving information, and the like.

According to an example embodiment, a history of a vehicle may be managed based on a blockchain structure. Hereinafter, the blockchain structure for managing a history of a vehicle will be described in more detail.

The blockchain structure for managing a history of a vehicle may include profile blocks.

A profile block may refer to a data structure in which a history of a vehicle is stored. A chain may be formed between a profile block and another profile block.

The profile block may include various information about a vehicle, and the various information about the vehicle may be associated with a user, as described above. The profile block may be classified in various ways based on information included in the profile block. That is, there may be various types of profile blocks, and data to be stored in a corresponding profile block may differ according to a type of the profile block.

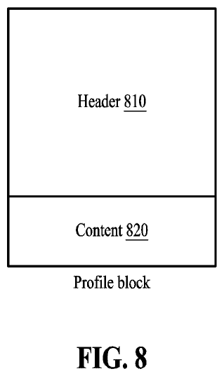

FIG. 8 is a diagram schematically illustrating a structure of a profile block according to an example embodiment.

Referring to FIG. 8, a profile block may include a header 810 and a content 820.

According to an example embodiment of the present disclosure, the header 810 may include the same type of data, regardless of a profile block type. The header 810 may be construed as including information of the profile block. The header 810 may identify a corresponding profile block and summarize the information about the corresponding profile block.

In an example embodiment, the header 810 may include a hash of the profile block. The hash of the profile block of the header 810 may include a hash value of the corresponding profile block.

The hash of the profile block may be a unique identifier of the profile block, i.e., the hash value of the hash of the header 810 may be used to identify the profile block. The hash of the profile block may be used to guarantee the integrity of data in the profile block and maintain a chain structure according to the present disclosure.

In an example embodiment, the hash value may be generated using a secure hash algorithm 256-bit (SHA-256) and any other hash function that is proven to be safe and secure.

In an example embodiment, the header 810 may include a hash of a previous profile block. Under the assumption that the profile block including the header 810 being described here is a “current profile block,” the previous profile block may be a profile block referred by the “hash of the previous profile block” of the header 810 of the current profile block. The hash of the previous profile block of the header 810 of the current profile block may include a hash value of the previous profile block, through which a chain may be formed between the current profile block and the previous profile block. That is, the previous profile block described herein may indicate a profile block that is referred by the current profile block and has a chain connected to the current profile block.

In an example embodiment, the header 810 may include a type of the profile block. The type of the profile block may include data or a value from which the type of the profile block is identifiable.

In an example embodiment, the header 810 may include a timestamp of the profile block. The timestamp may include time information about a time at which the profile block is generated. The timestamp of each profile block may be used to track the order in which profile blocks are generated and the time at which they are generated.

In an example embodiment, the header 810 may include a status of the profile block. The status of the profile block may include a value indicative of the status of the profile block, and the status of the profile block may include an active status and an inactive status.

According to an example embodiment of the present disclosure, the content 820 may include data representing different information depending on a profile block type. The content 820 of the profile block may include substantial information that is intended to be stored through the profile block, as opposed to the header 810, which includes the information of the profile block.

According to an example embodiment of the present disclosure, the content 820 may include data in any suitable form depending on a profile block type.

According to an example embodiment of the present disclosure, there may be two ways in which a new profile block is generated: one is minting a profile block, and the other is airdropping a profile block. For example, when a preset mint condition or a preset airdrop condition is met, a profile block may be minted or airdropped in response to a corresponding condition that is met. Whether a profile block is generated by minting or airdropping may be determined according to a type of the profile block, and the mint condition or the airdrop condition may also vary depending on a type of the profile block.

In an example embodiment, a third-type profile block may be minted or airdropped based on a category to which the third-type profile block belongs. For example, an activity profile block and a credential profile block may be generated by minting, and a voucher profile block and a badge profile block may be generated by airdropping.

According to an example embodiment of the present disclosure, a profile block may exist permanently or temporarily, depending on a type of the profile block or data included in the profile block. In an example embodiment, when a preset deactivation or discard condition is met, a generated profile block may be deactivated or discarded. For example, a profile block including user information may exist permanently, unless an account is deleted by a system administrator or a user. For example, a profile block including information about a vehicle usage credential, as in the case of rental, may be deactivated or discarded when a rental period elapses. In an example embodiment, the deactivated profile block may be reactivated and become again a profile block including valid data, whereas the discarded profile block may be irreversible.

In an example embodiment, a profile block may be user-dependent and non-transferable to another user. That is, a profile block may be a soulbound token. The soulbound token may be a permanent and immutable digital token whose ownership and transaction records are recorded in a blockchain. Accordingly, a history of a vehicle associated with a user may be transparently and securely stored, or its reliability may be ensured.

Hereinafter, different types of profile blocks will be described.

According to an example embodiment of the present disclosure, a profile block may include user information. For example, the content 820 of a profile block may include user information. In an example embodiment, the profile block including user information may be referred to as a first-type profile block.

As described above, a history of a vehicle may be a history that matches user information and, accordingly, the user information may be a reference used to manage the history of the vehicle. The first-type profile block including the user information may be a reference point or starting point of a blockchain structure for managing a history of a vehicle according to example embodiments of the present disclosure.

In an example embodiment, the first-type profile block may be issued in response to a user creating an account to manage a history of a vehicle. The account created by the user may be an account for accessing a system for managing a history of a vehicle (or simply a “vehicle history management system” herein) according to example embodiments of the present disclosure. The first-type profile block may include information about the account created by the user. Thus, the first-type profile block may be a profile block that is initially generated with respect to the user.

According to an example embodiment of the present disclosure, a profile block may include vehicle information. For example, the content 820 of a profile block may include vehicle information. In an example embodiment, the profile block including the vehicle information may be referred to as a second-type profile block.

According to an example embodiment of the present disclosure, the vehicle information may be dependent on a user based on user information. That is, the second-type profile block including the vehicle information may be dependent on the first-type profile block including the user information.

In an example embodiment, a chain may be formed between the first-type profile block and the second-type profile block. That is, a hash of a previous profile block of the second-type profile block may be a hash of the first-type profile block. In other words, as a hash value of the hash of the first-type profile block is input as a hash value of the hash of the previous profile block of the second-type profile block, the chain may be formed between the first-type profile block and the second-type profile block.

According to an example embodiment of the present disclosure, such a chain structure between the first-type profile block and the second-type profile block may be used to match the vehicle information and the user information and manage the matched information, and may also ensure the integrity of data related to a history of a vehicle associated with the user.

In an example embodiment, the second-type profile block may be issued after the first-type profile block is issued.

In an example embodiment, the second-type profile block may be issued as the user registers the vehicle on the vehicle history management system (or service). In another example embodiment, the second-type profile block may be issued automatically by the provision of a vehicle-related service such as a vehicle rental service. In this case, the vehicle-related service may be associated with the vehicle history management system described herein.

As described above, the vehicle may be owned by the user (e.g., the user corresponding to the first-type profile block) or by someone other than the user, i.e., a third party. For example, a case where the vehicle belongs to the third party may correspond to a case where the user rents the vehicle through a vehicle rental service.

In an example embodiment, there may be a plurality of second-type profile blocks associated with a single user. That is, there may be a plurality of second-type profile blocks that form chains with the first-type profile block. In this case, hashes of previous profile blocks of the plurality of second-type profile blocks may all be the hash of the first-type profile block.

For example, one of the plurality of second-type profile blocks forming a chain with the first-type profile block may be a profile block including vehicle information corresponding to a vehicle owned by the user, and another of the plurality of second-type profile blocks may be a profile block including vehicle information corresponding to a vehicle rented by the user. In this case, when there is a plurality of vehicles owned by the user, there may also be a plurality of profile blocks corresponding to the vehicles owned by the user, and when there is a plurality of vehicles rented by the user, there may also be a plurality of profile blocks corresponding to the vehicles rented by the user. In addition, a second-type profile block may be generated for any vehicle associated with the user, even for a vehicle that is not owned by the user or rented by the user.

According to an example embodiment of the present disclosure, a profile block may include vehicle-related sub-information. For example, the content 820 of a profile block may include vehicle-related sub-information. In an example embodiment, the profile block including the vehicle-related sub-information may be referred to as a third-type profile block.

According to an example embodiment of the present disclosure, the vehicle information included in the second-type profile block may refer to information about a vehicle itself including, for example, a type, a model, a year, specifications, and the like of the vehicle, while the vehicle-related sub-information included in the third-type profile block may refer to information that is generated, changed, or deleted as the vehicle is used, excluding the information about the vehicle itself.

The vehicle-related sub-information may be about a driving record, an accident record, user eligibility, and the like, and there may be different third-type profile blocks depending on what information they contain. That is, the administrator using the vehicle history management system may set vehicle-related sub-information to be included in a third-type profile block based on arbitrary criteria.

In an example embodiment, the third-type profile block may be classified into one of a plurality of preset categories based on information it contains. The administrator (e.g., a control server) of the vehicle history management system may set in advance categories, which are references to which the third-type profile block is classified.

Hereinafter, an example embodiment of categories into which the third-type profile block is classified will be described in more detail. The third-type profile block may be classified based on the categories described below.

In an example embodiment, a third-type profile block may be a profile block including activity information of a user associated with a vehicle. In an example embodiment, the third-type profile block including the activity information of a user associated with a vehicle may be referred to as an activity profile block.

In an example embodiment, the activity information may include, for example, a driving record, an accident record, a repair record, a vehicle usage record, and the like. That is, the activity profile block may include data representing the driving record, the accident record, the repair record, the vehicle usage record, and the like.

In an example embodiment, a single activity profile block may include all sets of activity information, or the activity information may be appropriately distributed and managed in a plurality of activity profile blocks. That is, there may be a plurality of activity profile blocks for a single vehicle.

In an example embodiment, a third-type profile block may be a profile block including credential information of a user associated with a vehicle. In an example embodiment, the third-type profile block including the credential information of a user associated with a vehicle may be referred to as a credential profile block.

In an example embodiment, the credential information may include the nature of a credential of the user for the vehicle, an expiration period of the credential, membership information, and the like. That is, the credential profile block may include data representing the nature of the credential of the user for the vehicle, the expiration period of the credential, the membership information, and the like. For example, in a case where a vehicle is rented by a user, the credential profile block may include information indicating that the user rents the vehicle, a rental period, and the like.

In an example embodiment, a single credential profile block may include all sets of credential information, or the credential information may be appropriately distributed and managed in a plurality of credential profile blocks. That is, there may be a plurality of credential profile blocks for a single vehicle.

In an example embodiment, a third-type profile block may be a profile block including additional service information about additional services available to a user associated with a vehicle. In an example embodiment, the third-type profile block including the additional service information may be referred to as a voucher profile block.

In an example embodiment, the additional service information may include various coupons, a parking voucher, a gas voucher, a recharge voucher, and the like, which may be available to the user for using the vehicle. That is, the voucher profile block may include data representing the coupons, the parking voucher, the gas voucher, the recharge voucher, and the like.

In an example embodiment, a single voucher profile block may include all sets of additional service information, or the additional service information may be appropriately distributed and managed in a plurality of voucher profile blocks. That is, there may be a plurality of voucher profile blocks for a single vehicle.

In an example embodiment, a third-type profile block may be a profile block including community participation eligibility information associated with a vehicle. In an example embodiment, the third-type profile block including the community participation eligibility information associated with a vehicle may be referred to as a badge profile block.

A community described herein may refer to a space where a user may do social networking activities through participation. Through the community, the user may do various activities including, for example, communicating with other users, sharing information, generating polls, participating in polls, participating in discussions, and the like.

In an example embodiment, the community may be a decentralized autonomous organization (DAO). The DAO may refer to an organization that, unlike a traditional organization structure, has no centralized control and operates by decision-making among participants in the community. The rules and operating methods of the DAO may be included in a smart contract and may be governed by consensus, voting, and the like by the participants of the DAO. The decision-making process in the DAO may be transparent and public. Thus, in a case of a community which is the DAO, participants in the community may more freely engage in activities (e.g., vehicles, services, etc.) related to the community, for example, discussing and suggesting improvements, depending on the topic, purpose, or nature of the community.

In an example embodiment, a community may be generated to be associated with a vehicle. Specifically, in a community, users who have something in common regarding the vehicle may only participate. For example, a first community may be a community in which only users who own a vehicle of a specific brand may participate. For example, a second community may be a community in which only users who own vans may participate. For example, a third community may be a community in which only users who rent vehicles of a particular type or model may participate. For example, a fourth community may be a community in which only users using a specific vehicle rental service may participate. In addition to these examples described above, a community may be generated in any arbitrary manner using various criteria by which vehicles or users may be classified. A community may be generated by the administrator (e.g., a control server) of the vehicle history management system.

In an example embodiment, an activity to be performed may differ according to users even in the same community. In addition, in an example embodiment, an activity to be performed by a user may differ according to a community in which the user participates. For example, a first user may only be able to view posts in a first community. For example, the first user may be able to create a poll in a second community, and a second user may only be able to participate in the poll in the second community.

As described above, the badge profile block may be a profile block including the community participation eligibility information. Therefore, in an example embodiment, the badge profile block may include data representing information about a community in which a user is able to participate, an activity the user is able to perform in the community, a period of time the user is able to participate in the community, a level of participation in the community, and the like.

According to an example embodiment of the present disclosure, the third-type profile block may be a profile block including the vehicle-related sub-information, and the vehicle-related sub-information may be dependent on a vehicle. Thus, the third-type profile block including the vehicle-related sub-information may be dependent on the second-type profile block including the vehicle information.

In an example embodiment, a chain may be formed between the second-type profile block and the third-type profile block. That is, a hash of a previous profile block of the third-type profile block may be a hash of the second-type profile block. In other words, as a hash value of the hash of the second-type profile block is input as a hash value of the hash of the previous profile block of the third-type profile block, the chain may be formed between the second-type profile block and the third-type profile block.

In an example embodiment, a chain may also be formed between third-type profile blocks. That is, a hash of a previous profile block of a third-type profile block may be a hash of another third-type profile block. In other words, as a hash value of the hash of the previous profile block of the third-type profile block is input as a hash value of the hash of the other third-type profile block, the chain may be formed between these third-type profile blocks.

In addition, any one of a plurality of third-type profile blocks that is connected through the chain may form a chain with the second-type profile block. Thus, even when the chain is formed between the third-type profile blocks, tracking the chain may identify which third-type profile block includes data associated with which vehicle.

According to an example embodiment of the present disclosure, when a third-type profile block is generated, whether a chain is formed with the second-type profile block or with a different third-type profile block, i.e., whether a hash value of a hash of the second-type profile block or a hash value of a hash of the different third-type profile block is input as a hash value of a hash of a previous profile block of the generated third-type profile block may depend on data included in the generated third-type profile block. According to an example embodiment of the present disclosure, the administrator (e.g., a control server) of the vehicle history management system may set any criteria or reference to ensure that a chain is formed between a newly generated profile block and any profile block. Alternatively, as a hash of another profile block is manually input into a hash of a previous profile block of the newly generated profile block, a chain may be formed.

In an example embodiment, based on a category of a third-type profile block, whether a chain for the third-type profile block is formed with the second-type profile block or with another third-type profile block may be determined.

In an example embodiment, for a plurality of third-type profile blocks classified into the same category, only one of the plurality of third-type profile blocks may form a chain with the second-type profile block.

In a specific example embodiment, in a case where a newly generated third-type profile block is classified into a first category, whether there is another third-type profile block that is associated with a vehicle corresponding to the newly generated third-type profile block (i.e., associated with the second-type profile block) and is classified into the first category may be verified. When another third-type profile block of the first category is not present, a chain may be formed between the newly generated third-type profile block and the second-type profile block. When another third-type profile block of the first category is present, a chain may be formed between the newly generated third-type profile block and any of other third-type profile blocks of the first category.

For example, in a case where a newly generated third-type profile block is an activity profile block and includes activity information about a first vehicle, and no other activity profile block associated with the first vehicle is present, a chain may be formed between the newly generated third-type profile block and a second-type profile block corresponding to the first vehicle. However, in this case, when another activity profile block associated with the first vehicle is already present, a chain may be formed between the newly generated third-type profile block and any of existing activity profile blocks.

On the other hand, in a case where a newly generated third-type profile block is associated with a vehicle for which no other third-type profile block has been generated before, i.e., when it is associated with a second-type profile block with which no chain has been formed, a chain may be formed between the newly generated third-type profile block and the second-type profile block, regardless of a category of the newly generated third-type profile block.

In an example embodiment, there may be a plurality of third-type profile blocks that form a chain with the second-type profile block. This is because there may be various types of sub-information associated with a single vehicle. In this case, hashes of previous profile blocks of the plurality of third-type profile blocks may all be a hash of the second-type profile block.

For example, in a case where the second-type profile block is a profile block including information of a first vehicle, any one of the plurality of third-type profile blocks that form a chain with the second-type profile block may be a third-type profile block that is an activity profile block associated with the first vehicle, and any other of the plurality of third-type profile blocks may be a third-type profile block that is a credential profile block associated with the first vehicle.

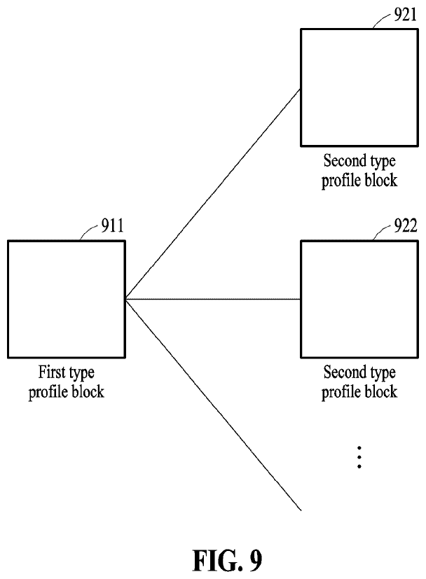

FIG. 9 is a diagram illustrating a connection relationship between a first-type profile block and a second-type profile block according to an example embodiment.

As described above, vehicle information may be dependent on a user according to user information. That is, a second-type profile block including vehicle information may be dependent a first-type profile block including user information. Based on such a characteristic, in an example embodiment, a chain may be formed between the first-type profile block and the second-type profile block. That is, a hash of a previous profile block of the second-type profile block may be a hash of the first-type profile block.

Referring to FIG. 9, there is shown a connection relationship between a first-type profile block 911 and a second-type profile block 921, which may indicate a chain formed between the first-type profile block 911 and the second-type profile block 921. That is, referring to FIG. 9, a hash of a previous profile block of the second-type profile block 921 may be a hash of the first-type profile block 911.

As described above, there may be a plurality of second-type profile blocks associated with a single user. That is, there may be a plurality of second-type profile blocks that form a chain with a first-type profile block.

Referring to FIG. 9, both the second-type profile block 921 and a second-type profile block 922 may have a connection relationship with the first-type profile block 911, which may indicate that a chain is formed between the first-type profile block 911 and the second-type profile block 921 and a chain is formed between the first-type profile block 911 and the second-type profile block 922. That is, in FIG. 9, as with the second-type profile block 921, a hash of a previous profile block of the second-type profile block 922 may be the hash of the first-type profile block 911.

For example, referring to FIG. 9, the second-type profile block 921 may be a profile block including vehicle information corresponding to a vehicle owned by a user, and the second-type profile block 922 may be a profile block including vehicle information corresponding to a vehicle rented by the user.

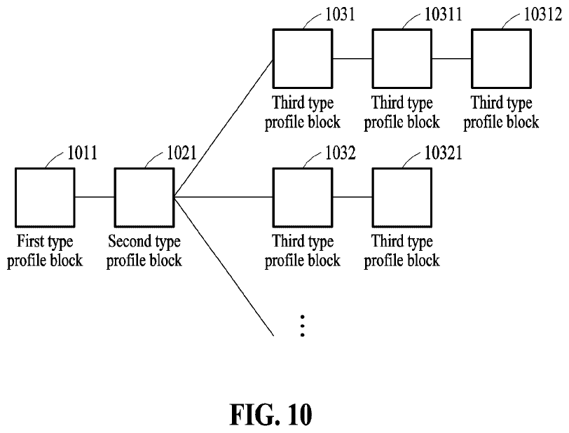

FIG. 10 is a diagram illustrating a connection relationship among a first-type profile block, a second-type profile block, and a third-type profile block according to an example embodiment.

Referring to FIG. 10, a chain may be formed between a first-type profile block 1011 and a second-type profile block 1021, which has been described above with reference to FIG. 9 and will not be detailed and repeated here for brevity. For ease of description, only the second-type profile block 1021 is shown as forming a chain with the first-type profile block 1011, but it will be readily understood by one of ordinary skill in the art that additional second-type profile blocks may form a chain with the first-type profile block 1011.

As described above, vehicle-related sub-information may be dependent on a vehicle, and thus a third-type profile block including the vehicle-related sub-information may be dependent on a second-type profile block including vehicle information. Based on this characteristic, in an example embodiment, a chain may be formed between the third-type profile block and a second-type profile block corresponding to the third-type profile block. That is, a hash of a previous profile block of the third-type profile block may be a hash of the second-type profile block.

Referring to FIG. 10, there is shown a connection relationship between the second-type profile block 1021 and a third-type profile block 1031, which may indicate a chain formed between the second-type profile block 1021 and the third-type profile block 1031. That is, in FIG. 10, a hash of a previous profile block of the third-type profile block 1031 may be a hash of the second-type profile block 1021.

As described above, there may be a plurality of third-type profile blocks associated with a single vehicle, i.e., there may be a plurality of third-type profile blocks forming a chain with a second-type profile block.

Referring to FIG. 10, both the third-type profile block 1031 and a third-type profile block 1032 may have a connection relationship with the second-type profile block 1021, which may indicate a chain formed between the second-type profile block 1021 and the third-type profile block 1031 and a chain formed between the second-type profile block 1021 and the third-type profile block 1032. That is, in FIG. 10, as with the third-type profile block 1031, a hash of a previous profile block of the third-type profile block 1032 may be the hash of the second-type profile block 1021.

For example, referring to FIG. 10, in a case where the first-type profile block 1011 includes user information associated with a first user and the second-type profile block 1021 includes vehicle information associated with a first vehicle, the third-type profile block 1031 may be an activity profile block including activity information of the first user with respect to the first vehicle, and the third-type profile block 1032 may be a credential profile block including credential information of the first user with respect to the first vehicle.

As described above, a chain may be formed between third-type profile blocks, i.e., a hash of a previous profile block of one third-type profile block may be a hash of another third-type profile block.

For example, referring to FIG. 10, a chain may be formed between the third-type profile block 1031 and a third-type profile block 10311, a chain may be formed between the third-type profile block 10311 and a third-type profile block 10312, and a chain may be formed between the third-type profile block 1032 and a third-type profile block 10321. That is, a hash of a previous profile block of the third-type profile block 10311 may be a hash of the third-type profile block 1031, a hash of a previous profile block of the third-type profile block 10312 may be the hash of the third-type profile block 10311, and a hash of a previous profile block of the third-type profile block 10321 may be a hash of the third-type profile block 1032.

For example, referring to FIG. 10, the third-type profile block 1031, the third-type profile block 10311, and the third-type profile block 10312 may be profile blocks classified into a first category, and the third-type profile block 1032 and the third-type profile block 10321 may be profile blocks classified into a second category.

As a specific example, the third-type profile block 1031, the third-type profile block 10311, and the third-type profile block 10312 may all be activity profile blocks, and the third-type profile block 1032 and the third-type profile block 10321 may all be credential profile blocks. In this case, the third-type profile block 1031 may include a driving record, the third-type profile block 10311 may include an accident record, and the third-type profile block 10312 may include a repair record. In addition, the third-type profile block 1032 may include the nature of a credential of a user for a vehicle, and the third-type profile block 10321 may include an expiration period of the credential of the user for the vehicle.

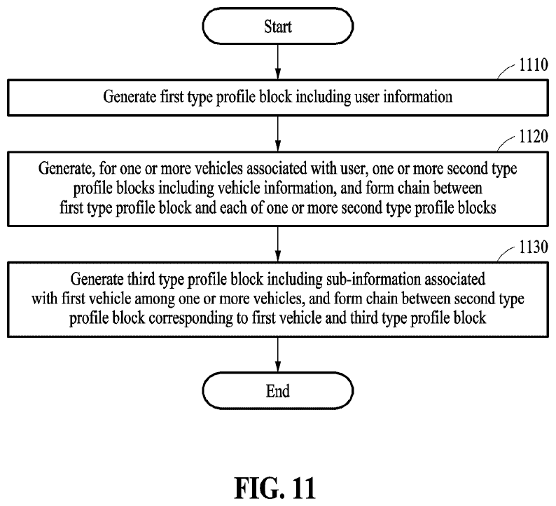

FIG. 11 is a flowchart illustrating a blockchain structure-based user-associated vehicle history management method according to an example embodiment. The blockchain structure-based user-associated vehicle history management method may refer to a method of managing a history of a vehicle associated with a user based on a blockchain structure.

Operations described below with reference to FIG. 11 may be performed by a blockchain structure-based user-associated vehicle history management device (which is a device for managing a history of a vehicle associated with a user based on a blockchain structure) described above. Specifically, the operations described below with reference to FIG. 11 may be performed by a processor included in the blockchain structure-based user-associated vehicle history management device described above.

In operation 1110, the processor may generate a first-type profile block including user information.

In operation 1120, the processor may generate one or more second-type profile blocks including vehicle information for one or more vehicles associated with a user, and may form a chain between the first-type profile block and each of the one or more second-type profile blocks.

In operation 1130, the processor may generate a third-type profile block including sub-information associated with a first vehicle among the one or more vehicles, and form a chain between a second-type profile block corresponding to the first vehicle and the third-type profile block.

In an example embodiment, each profile block may include a header including information about a corresponding profile block and a content including information that is intended to be stored through the profile block.

In an example embodiment, each profile block may depend on a user and may thus be non-transferable to other users.

In an example embodiment, operation 1120 may include inputting a hash value of the first-type profile block into a header of the second-type profile block.

In an example embodiment, operation 1130 may include inputting a hash value of the second-type profile block into a header of the third-type profile block.

In an example embodiment, the sub-information may include any one of activity information of the user associated with the first vehicle, credential information of the user associated with the first vehicle, additional service information about additional services available to the user associated with the first vehicle, and community participation eligibility information associated with the first vehicle.

In an example embodiment, when the third-type profile block is a first third-type profile block, and the processor may further perform the following operations: generating a second third-type profile block including the sub-information associated with the first vehicle; when the first third-type profile block and the second third-type profile block are classified into the same category, forming a chain between the first third-type profile block and the second third-type profile block; and when the first third-type profile block and the second third-type profile block are classified into different categories, forming a chain between the second-type profile block corresponding to the first vehicle and the second third-type profile block.

In an example embodiment, the processor may further perform the following operations: generating a third third-type profile block including sub-information associated with a second vehicle among the one or more vehicles; and forming a chain between a second-type profile block corresponding to the second vehicle and the third third-type profile block.

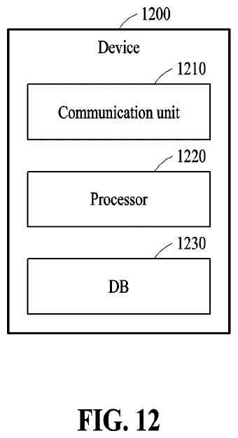

FIG. 12 is a block diagram illustrating a blockchain structure-based user-associated vehicle history management device according to an example embodiment.

Referring to FIG. 12, a blockchain structure-based user-associated vehicle history management device 1200 (or simply a “device 1200” as illustrated) may include a communication unit 1210, a processor 1220, and a DB 1230. Although only components related to an example embodiment of the blockchain structure-based user-associated vehicle history management device 1200 are shown in FIG. 12, it is apparent to those having ordinary skill in the art that the device 1200 may include other general-purpose components in addition to those shown in FIG. 12.

The communication unit 1210 may include one or more components that enable wired or wireless communication with an external server or external device. The communication unit 1210 may include, for example, at least one of a short-range communication unit (not shown), a mobile communication unit (not shown), and a broadcast receiving unit (not shown).

The DB 1230, which is hardware storing therein various data processed in the device 1200, may store a program for processing and controlling the processor 1220. The DB 1230 may store payment information, user information, and the like.

The DB 1230 may include a random-access memory (RAM) such as a dynamic random-access memory (DRAM) and a static random-access memory (SRAM), a read-only memory (ROM), an electrically erasable programmable read-only memory (EEPROM), a compact disc read-only memory (CD-ROM), Blu-ray or other optical disc storage, a hard disk drive (HDD), a solid-state drive (SSD), or a flash memory.

The processor 1220 may control the overall operation of the blockchain structure-based user-associated vehicle history management device 1200. For example, the processor 1220 may execute the program stored in the DB 1230 to control the overall operations of an input unit (not shown), a display (not shown), the communication unit 1210, the DB 1230, and the like. By executing the program stored in the DB 1230, the processor 1220 may control the operations performed by the blockchain structure-based user-associated vehicle history management device 1200.

The processor 1220 may control at least some of the operations of the blockchain structure-based user-associated vehicle history management device 1200 based on the blockchain structure described above with reference to FIGS. 7 through 11.

The processor 1220 may be implemented using at least one of an application-specific integrated circuit (ASIC), a digital signal processor (DSP), a digital signal processing device (DSPD), a programmable logic device (PLD), a field-programmable gate array (FPGA), a controller, a microcontroller, a microprocessor, and other electrical units for performing functions.

In an example embodiment, the blockchain structure-based user-associated vehicle history management device 1200 may be a movable electronic device. For example, the blockchain structure-based user-associated vehicle history management device 1200 may be implemented as, for example, a smartphone, a personal computer (PC), a tablet PC, a smart television (TV), a personal digital assistant (PDA), a laptop, a media player, a navigation system, a camera-equipped device, or other mobile electronic device. The blockchain structure-based user-associated vehicle history management device 1200 may also be implemented as, for example, a wearable device such as a watch, glasses, a hair band, or a ring that has a communication function and a data processing function.

In another example embodiment, the blockchain structure-based user-associated vehicle history management device 1200 may be a vehicle-embedded electronic device. For example, the blockchain structure-based user-associated vehicle history management device 1200 may be an electronic device that is inserted into a vehicle through tuning after being produced in a production process.

In another example embodiment, the blockchain structure-based user-associated vehicle history management device 1200 may be a server present outside a vehicle. The server may be implemented as, for example, a computer device or a plurality of computer devices that communicates over a network to provide commands, code, files, contents, services, and the like. The server may receive data necessary to determine a travel path of the vehicle from devices provided in the vehicle, and may determine the travel path of the vehicle based on the received data.

In another example embodiment, the processes performed by the blockchain structure-based user-associated vehicle history management device 1200 may be performed by at least some of the movable electronic device, the vehicle-embedded electronic device, and the server present outside a vehicle.

The blockchain structure-based user-associated vehicle history management method described above with reference to FIGS. 7 through 12 according to an example embodiment may allow a user to search and manage a history associated with the user in an integrated manner. Through the blockchain structure-based user-associated vehicle history management method, a history of a vehicle associated with the user is managed based on a blockchain structure, and thus the reliability and integrity of information may be ensured. In addition, since the history of the vehicle is managed in association with the user, the history of the vehicle may be valuable as a new type of information. Further, on an administrator's side, the administrator may classify vehicle-related information into categories in an arbitrary manner and apply the blockchain structure-based user-associated vehicle history management method described herein accordingly, increasing the availability.

According to an example embodiment, the blockchain structure-based user-associated vehicle history management method may include: generating a first-type profile block including user information; generating one or more second-type profile blocks including vehicle information about one or more vehicles associated with a user, and forming a chain between the first-type profile block and each of the one or more second-type profile blocks; and generating a third-type profile block including sub-information about a first vehicle among the one or more vehicles, and forming a chain between a second-type profile block corresponding to the first vehicle and the third-type profile block.

According to an example embodiment, the sub-information may include any one of activity information of the user associated with the first vehicle, credential information of the user associated with the first vehicle, additional service information about additional services available to the user associated with the first vehicle, and community participation eligibility information associated with the first vehicle.

According to an example embodiment, each of the profile blocks may include a header including information of a corresponding profile block, and a content including information that is intended to be stored through the profile block.

According to an example embodiment, the forming of the chain between the first-type profile block and the second-type profile block may include inputting a hash value of the first-type profile block into a header of the second-type profile block, and the forming of the chain between the second-type profile block and the third-type profile block may include inputting a hash value of the second-type profile block into a header of the third-type profile block.

According to an example embodiment, the third-type profile block may be a first third-type profile block, and in this case, the blockchain structure-based user-associated vehicle history management method may further include: generating a second third-type profile block including sub-information associated with the first vehicle among the one or more vehicles; when the first third-type profile block and the second third-type profile block are classified into the same category, forming a chain between the first third-type profile block and the second third-type profile block; and when the first third-type profile block and the second third-type profile block are classified into different categories, forming a chain between the second-type profile block corresponding to the first vehicle and the second third-type profile block.

According to an example embodiment, the blockchain structure-based user-associated vehicle history management method may further include generating a third third-type profile block including sub-information associated with a second vehicle among the one or more vehicles, and forming a chain between a second-type profile block corresponding to the second vehicle and the third third-type profile block.

According to an example embodiment, each of the profile blocks may be dependent on the user and non-transferable to another user.

According to an example embodiment, the blockchain structure-based user-associated vehicle history management device may include: a memory storing at least one program; and a processor configured to operate by executing the at least one program. The processor may be configured to: generate a first-type profile block including user information; generate one or more second-type profile blocks including vehicle information about one or more vehicles associated with a user, and form a chain between the first-type profile block and each of the one or more second-type profile blocks; and generate a third-type profile block including sub-information associated with a first vehicle among the one or more vehicles, and form a chain between a second-type profile block corresponding to the first vehicle and the third-type profile block.

According to an example embodiment, a computer-readable recording medium may record therein a program for executing a blockchain structure-based user-associated vehicle history management method on a computer. The blockchain structure-based user-associated vehicle history management method may include: generating a first-type profile block including user information; generating one or more second-type profile blocks including vehicle information about one or more vehicles associated with a user, and forming a chain between the first-type profile block and each of the one or more second-type profile blocks; and generating a third-type profile block including sub-information about a first vehicle among the one or more vehicles, and forming a chain between a second-type profile block corresponding to the first vehicle and the third-type profile block.

The example embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device, comprising:
a memory comprising instructions; and
a processor electrically connected to the memory and configured to execute the instructions,
wherein, when the instructions are executed by the processor, the processor is configured to perform a plurality of operations,
wherein the plurality of operations comprises:
recording a driver registration result of a vehicle owner in profile data stored in a blockchain; and
generating a combination identifier (CID) in which a vehicle and a driver are mapped by mapping vehicle information and driver information recorded in the profile data,
wherein the CID is segmented into blockchain-based decentralized identifiers (DIDs) respectively corresponding to vehicle usage scenarios of the driver, and
the CID comprises at least one of vehicle information, driver information, vehicle owner information, or CID type information.

2. The electronic device of claim 1, wherein the profile data comprises:
a profile base storing a vehicle list, a driver list, and vehicle owner information; and
a profile list storing a CID list and CID type information.

3. The electronic device of claim 2, wherein the CID type information comprises:
information about a vehicle-driver relationship.

4. The electronic device of claim 2, wherein the profile base and the profile list are configured to store information in the form of a table and to manage the information in a tree structure.

5. The electronic device of claim 1, wherein the plurality of operations further comprises:
in response to a request for a DID corresponding to a vehicle usage scenario of the driver, issuing a DID corresponding to the vehicle usage scenario and based on the CID.

6. The electronic device of claim 5, wherein the plurality of operations further comprises:
in response to a request for a verifiable credential (VC) from the driver, issuing a VC based on the DID,
wherein the VC corresponds to a credential owned by the driver or a credential delegated to the driver.

7. The electronic device of claim 6, wherein the VC corresponds to a vehicle operation credential or a vehicle service usage credential.

8. The electronic device of claim 7, wherein the DID and the VC are used to generate a verifiable presentation (VP) corresponding to the vehicle usage scenario of the driver.

9. The electronic device of claim 8, wherein the VP is used to authenticate and authorize a vehicle-related service the driver desires to receive.

10. A blockchain-based user identification method for a mobility service, comprising:
recording a driver registration result of a vehicle owner in profile data stored in a blockchain; and
generating a combination identifier (CID) in which a vehicle and a driver are mapped by mapping vehicle information and driver information recorded in the profile data,
wherein the CID is segmented into blockchain-based decentralized identifiers (DIDs) respectively corresponding to vehicle usage scenarios of the driver, and
the CID comprises at least one of vehicle information, driver information, vehicle owner information, or CID type information.

11. The method of claim 10, wherein the profile data comprises:
a profile base storing a vehicle list, a driver list, and vehicle owner information; and
a profile list storing a CID list and CID type information.

12. The method of claim 11, wherein the CID type information comprises:
information about a vehicle-driver relationship.

13. The method of claim 10, wherein the profile base and the profile list are configured to store information in the form of a table and to manage information in a tree structure.

14. The method of claim 10, further comprising:
in response to a request for a DID corresponding to a vehicle usage scenario of the driver, issuing a DID corresponding to the vehicle usage scenario and based on the CID.

15. The method of claim 14, further comprising:
in response to a request for a verifiable credential (VC) from the driver, issuing a VC based on the DID,
wherein the VC corresponds to a credential owned by the driver or a credential delegated to the driver.

16. The method of claim 15, wherein the VC corresponds to a vehicle operation credential or a vehicle service usage credential.

17. The method of claim 16, wherein the DID and the VC are used to generate a verifiable presentation (VP) corresponding to the vehicle usage scenario of the driver.

18. The method of claim 17, wherein the VP is used to authenticate and authorize a vehicle-related service the driver desires to receive.
